(19) United States
(12) Patent Application Publication
(10) Pub. No.: US 2007/0259580 A1
(43) Pub. Date: Nov. 8, 2007

(54) Cleaning pad for flatwork ironer

(75) Inventors: Hector Hernandez, Chicago, IL (US); Leo Pearl, Evanston, IL (US)

Correspondence Address: GREER, BURNS & CRAIN, 300 S WACKER DR, 25TH FLOOR, CHICAGO, IL, 60606, US

(73) Assignee: RESILLO PRESS PAD COMPANY

(21) Appl. No.: 11/429,537

(22) Filed: May 5, 2006

(51) Int. Cl. D04H 1/00; B32B 15/14; B32B 23/02; B32B 5/26; A47L 13/00

(52) U.S. Cl. 442/2; 428/192; 442/13; 442/326; 15/104.001

(57) ABSTRACT

A flatwork ironer cleaning pad includes a carrier layer having a leading edge portion, a cleaning portion and a trailing edge portion and a sand screen sheet secured to the cleaning portion.

### BACKGROUND OF THE INVENTION

The present invention relates to the commercial laundry industry, and specifically to an improved cleaning pad for flatwork ironers used in establishments such as hotels, hospitals, nursing homes and other commercial laundry facilities.

Commercial flatwork ironers include padded rolls carrying the sheets or flatwork against a heated chest which performs the pressing action. During prolonged use, the sheets deposit residual detergents and other additives upon the chest which reduces the efficiency of the ironer. More specifically, when the chest becomes coated with residue, the residue interferes with the passage of the sheets through the ironer. In some cases, the flatwork pieces become distorted.

To address this problem, it is known to place flatwork ironer cleaning pads into the ironers to clean the chest. Conventional flatwork ironer cleaning pads, notably the KLEENO-PAD® pad manufactured by the present Assignee, the Resillo Press Pad Co. in Lincolnwood, Ill., include a carrier layer of cotton duck or spun polyester having a leading edge portion, a cleaning portion and a trailing edge portion. The cleaning portion includes several spaced parallel rows of braided steel wool cloth running transverse to the direction of travel of the pad through the rollers, or parallel with the longitudinal axis of the rollers. The rows of braided steel wool are welded to a sheet of metal stainless steel mesh, which in turn is secured to the carrier layer with staples. Next, the trailing edge portion is provided with several spaced parallel rows of polishing felt. In the case of both the braided steel wool and the polishing felt, the respective cleaning and polishing materials project above the carrier layer approximately 1 inch. In some cases, the use of the cleaning pad is followed by the insertion of a waxing pad to wax the chest.

It has been found that newer model flatwork ironers have a narrower intake area. As such, when conventional cleaner pads are inserted into the machines, the steel wool braids, among other components, are pulled from the carrier layer. Aside from interfering with the cleaning process, the destruction of the pad leaves residue in the ironer which must be removed.

One attempted solution has been to use sheets of silicate-coated screen cloth or commonly known material referred to as “sand screen”. Such material is thinner than the conventional cleaning pad, and upon insertion into the machine, passes easily between the rollers and the chest. However, after a relatively few passes through the ironer, the sand screen material deteriorates and crumbles in the ironer, leaving excessive amounts of a powdery residue, which, if not removed, will soil the clean linen passed through the ironer. Again, special procedures are required to remove the residue from the decomposed sand screen sheets.

Thus, there is a need for an improved flatwork ironer cleaning pad which overcomes the disadvantages of conventional pads used on newer ironers with narrower insert openings. There is also a need for such an improved pad which can withstand repeated use in newer ironers.

### BRIEF SUMMARY OF THE INVENTION

Accordingly, the above-identified drawbacks of conventional flatwork ironer cleaner pads used in contemporary ironers are overcome with the present pad, overcomes production difficulties. The present cleaner pad employs a layer of sand screen cloth secured to a carrier layer of cotton duck or spun polyester, disposed between a leading edge portion and a trailing edge portion. The trailing edge portion is preferably a continuous layer of felt for polishing purposes. An important feature of the present pad is the manner in which the sand screen is secured to the carrier layer, being stitched through an overlying hem or binder. The resulting pad moves through ironers more easily than prior pads, and is significantly more durable. Another feature of the present pad is that a separate application of a waxing pad is eliminated, since cleaning and waxing can be performed simultaneously.

More specifically, a flatwork ironer cleaning pad includes a carrier layer having a leading edge portion, a cleaning portion and a trailing edge portion and a sand screen sheet secured to the cleaning portion.

In another embodiment, a flatwork ironer cleaning pad includes a carrier layer having a leading edge portion, a cleaning portion and a trailing edge portion, a sand screen sheet disposed on the cleaning portion, a hem enveloping each side edge of the sand screen sheet and being stitched to both the sand screen sheet and the cleaning portion, and a felt layer secured to the trailing edge portion.

In still another embodiment, a flatwork ironer cleaning pad includes a carrier layer having a leading edge portion, a cleaning portion and a trailing edge portion, the leading edge portion having a pocket formed at a front edge, and a sand screen sheet disposed on the cleaning portion so that a substantial portion of the sand screen sheet lays directly upon the cleaning portion. A hem envelops each side edge of the sand screen sheet and is stitched to both the sand screen sheet and the cleaning portion. A continuous felt layer covers the trailing edge portion.

### BRIEF DESCRIPTION OF THE SEVERAL VIEWS OF THE DRAWINGS

FIG. 1 is a fragmentary perspective view of the present flatwork ironer cleaning pad;

FIG. 2 is a fragmentary vertical cross-section taken along the line 2-2 of FIG. 1;

FIG. 3 is a fragmentary vertical cross-section of an alternate to the embodiment of FIG. 2; and

FIG. 4 is a fragmentary perspective view of an alternate embodiment of the present flatwork ironer cleaning pad.

### DETAILED DESCRIPTION OF THE INVENTION

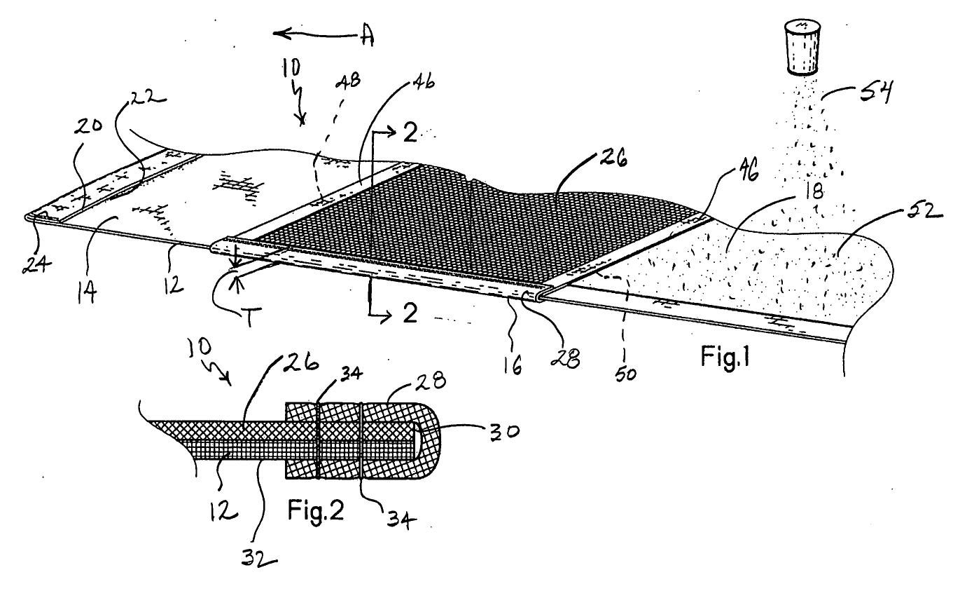

Referring now to FIGS. 1 and 2, the present flatwork ironer cleaning pad is generally designated 10 and includes a carrier layer 12 made of a sheet of durable, washable material such as no. 12 cotton duck or spun polyester, as is well known in the laundry machine cleaning industry. The carrier layer 12 is referred to as having a leading edge portion 14, a cleaning portion 16 adjacent the leading edge portion in the direction of travel of the pad 10 (indicated by the arrow A) through a laundry machine such as a flatwork ironer (not shown) and a trailing edge portion 18 next adjacent the cleaning portion.

At the leading edge portion 14, in the preferred embodiment a front edge 20 is folded back to form a pocket 22, which is then secured by being secured along side edges 24, preferably by stitching. The pocket is used to hold solvents as are known in the art for facilitating the breakdown of baked on deposits on the ironer rollers.

Referring now to the cleaning portion 16, as described above, an important factor in developing a flatwork ironer cleaning pad which is suitable for use in ironers is that the overall height or thickness “T” be thin enough to pass through the ironer without becoming damaged. For best results, it is preferred that the thickness “T” be less than or equal to 0.5 inch.

In the industry, it was known to use sand screen material to clean ironers, however the material was inserted in sheet form directly into the ironer after being cut to suitable size. Such material was made of a polymeric or fiberglass screen material, similar in construction to that used for window screens, and was coated with an abrasive particulate material to provide cleaning action. While silicon carbide is the preferred particulate abrasive, it is contemplated that other mineral abrasive-coated sheet materials may be used, such as aluminum oxide or synthetic minerals, as are well known in the abrasive materials art. For the purposes of this application, “sand screen” will refer to all such sheet materials coated or embedded with abrasive minerals for cleaning and/or polishing. Also, while screen material is preferred as the base for such cleaning sheets, it is contemplated that the mesh size of the material may vary to suit the application, and alternatives to screen material are also contemplated, provided that the material has sufficient abrasive action. Such sand screen material is commercially available from 3M Company, St. Paul, Minn., among others.

While effective in cleaning the rolls, the sand screen material used alone broke down or decomposed after only a few uses. In addition to adding to maintenance costs due to the more frequent required replacement of pads, the material also increased maintenance costs by requiring the removal of the residual powder formed by the decomposing pads. If not removed, the powder was deposited on laundry passing through the ironer.

To maintain a relatively thin profile, and keep the thickness “T” within desired parameters, it is preferred that a sheet of sand screen 26 is attached to the carrier layer 12 so that a majority of the sheet of silicate material is in direct contact with an inner surface 27 of the carrier layer. However it was found that securing the silicate material to the carrier layer 26 was not easily accomplished. Adhesives would break down under the hot damp working environment of the ironers and might stain the linen. Staples would have a relatively thick profile and might scratch the surface of the ironer's chests. Further, staples might fracture the silicate material.

While stitching with thread using industrial sewing machines is known in the manufacture of other types of laundry cleaning and pressing pads, it was found that sewing sand screen sheets to the carrier layer 12 caused the sewing needles to heat up and eventually disintegrate through exposure to the abrasive minerals. It was found that using a hem or binder of fabric 28 enveloping an edge 30 of the sand screen material 26 enabled the stitching to proceed without needle degradation. While other materials are contemplated, the hem 28 is preferably made of No. 12 cotton duck, which is also a desired material for the carrier layer 12.

Referring now to FIG. 2, it is preferred that the hem 28 cover the edge 30 and also a lower portion wraps around the sand screen 26 to contact an underside 32 of the carrier layer 12. In this embodiment, the hem 28 sandwiches the sand screen sheet 26 against the carrier layer 12, and is only found in the cleaning portion 16 of the pad 10. Also, by wrapping around the two joined materials, the hem 28 prevents users from becoming scratched by the sand screen sheet 26 during handling. Conventional industrial stitches 34 pass through the hem 28, the sand screen sheet 26 and the carrier layer 12. This arrangement is desirable in that it maintains “T” within desired parameters.

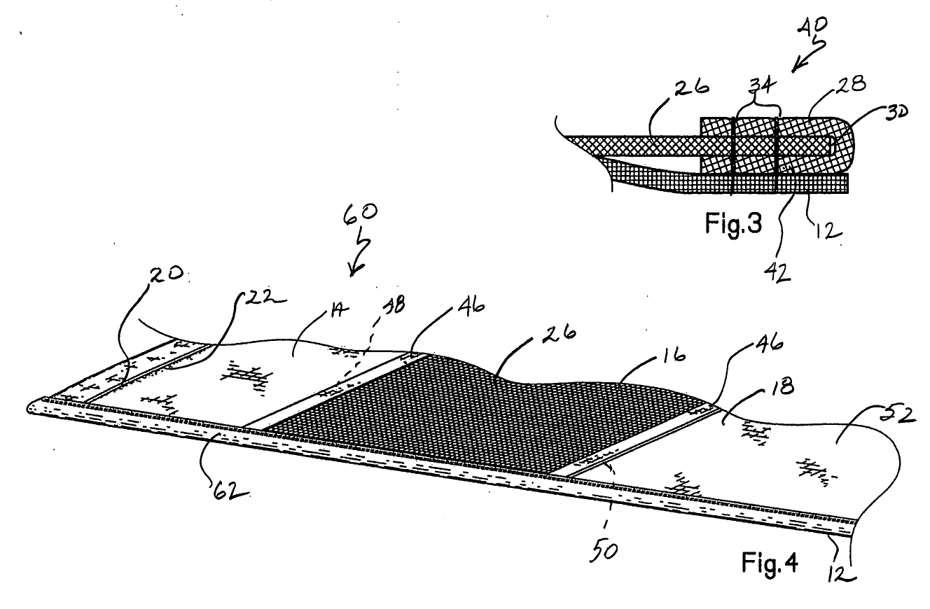

Referring now to FIG. 3, an alternative embodiment to that shown in FIG. 2 is generally designated 40, and shared components with the cleaning pad 10 are designated with identical reference numbers. The main distinction between the pads 40 and 10 is that in the pad 40 the hem 28 envelops only the sand screen sheet 26, covering upper and lower edge portions thereof, and the hem is sandwiched along a lower edge 42 between the sand screen sheet and the carrier layer 12. As in the case of the pad 10, stitches 34 pass through upper and lower edges of the hem 28, the sand screen sheet 26 and the carrier layer 12.

It is also contemplated that optional strips of binder material 46 be stitched along forward and rear edges 48, 50 (shown hidden) of the sand screen sheet 26 to further secure it to the carrier layer 12. These optional binder strips 46 may be used in either embodiment 10 or 40, and are preferably made of the same material as the hem 28; however other suitable materials used in cleaning pads are contemplated.

Referring again to FIG. 1, the trailing edge 18 is preferably provided with a layer of felt material 52. Cotton felt or flannel is known in the laundry maintenance industry for polishing and cleaning of ironer chests, and in conventional ironer cleaner pads it is typically provided in spaced parallel strips extending transversely to the direction of travel through the rollers and generally parallel to the axis of the rollers. However, since the conventional felt strips project approximately 1 inch above the carrier layer, they are unsuitable for use in more modem ironers. As described above, the use of conventional flatwork ironer cleaning pads in such ironers has caused the pads to be torn or damaged, and such damage includes tearing the felt strips.

Accordingly, to provide the desired cleaning and polishing of the ironer chests after the cleaning by the sand screen sheet 26, the felt layer 52 on the present pad 10, 40 is preferably continuous across and covers the entire trailing edge portion 18. This arrangement also helps maintain the thickness “T” of the pad 10 within the desired parameters for use in ironers, including newer model machines. Also, as is known in the art, it is preferable to add a coating of powdered wax 54 to the felt layer 52 to enhance the polishing action. Thus, by using the present pad 10, cleaning and waxing can be accomplished in a single application. Previously, users were forced to first insert a cleaning pad, then a waxing or polishing pad.

Referring now to FIG. 4, another alternative to the pads 10, 40 is generally designated 60, and shared components are designated with identical reference numbers. While in the pad 10, the hem 28 is located only along corresponding edges of the carrier layer 12 and the sand screen sheet 26, it is also contemplated in the pad 60 that a hem 62 may extend the full length of the carrier layer 12. In all other aspects, the pad 60 is identical to the pad 10. In this embodiment, it is not considered suitable to arrange the hem as depicted in embodiment 40 illustrated in FIG. 3.

It will be seen that the present pads 10, 40, 60 provide an effective and durable solution to the implementation of newer design ironers. By employing the hem 28, the sand screen sheets 26 may be readily secured to the carrier layer 12 without causing sewing needle deterioration. Further, the addition of solvent in the pocket 22 and powdered wax 54 on the trailing edge portion 18 results in a flatwork ironer cleaning system which is superior to conventional cleaning techniques.

While specific embodiments of the flatwork ironer cleaning pad of the present invention have been shown and described, it will be appreciated by those skilled in the art that changes and modifications may be made thereto without departing from the invention in its broader aspects and as set forth in the following claims.

What is claimed is:

1. A flatwork ironer cleaning pad, comprising:
a carrier layer having a leading edge portion, a cleaning portion and a trailing edge portion; and
a sand screen sheet secured to said cleaning portion.

2. The cleaning pad of claim 1 wherein said sand screen sheet is secured directly to said carrier layer by stitching.

3. The cleaning pad of claim 2 further including a hem overlapping corresponding upper and lower edge portions of said sand screen sheet, said sand screen sheet being stitched to said carrier layer through said hem.

4. The cleaning pad of claim 3 wherein a lower portion of said hem envelops said sand screen sheet and said carrier layer.

5. The cleaning pad of claim 3 wherein said lower portion of said hem is located only along corresponding edges of said carrier layer and said sand screen sheet.

6. The cleaning pad of claim 1 wherein said leading edge portion is provided with a pocket.

7. The cleaning pad of claim 1 further including a felt layer secured to said trailing edge portion.

8. The cleaning pad of claim 7 wherein said felt layer on said trailing edge portion covers said entire trailing edge portion.

9. The cleaning pad of claim 7 wherein said felt layer is continuous across said trailing edge portion.

10. A flatwork ironer cleaning pad, comprising:
a carrier layer having a leading edge portion, a cleaning portion and a trailing edge portion;
a sand screen sheet disposed on said cleaning portion;
a hem enveloping corresponding edges of said sand screen sheet and said cleaning portion and being stitched to both said sand screen sheet and said cleaning portion; and
a felt layer secured to said trailing edge portion.

11. The cleaning pad of claim 10 wherein a lower portion of said hem envelops said sand screen sheet and said carrier layer.

12. The cleaning pad of claim 10 wherein said lower portion of said hem is located between said sand screen sheet and said carrier layer.

13. The cleaning pad of claim 10 wherein a forward edge of said leading edge is provided with a pocket.

14. The cleaning pad of claim 10 further including an application of powdered wax on said felt layer.

15. The cleaning pad of claim 10 wherein said carrier layer is made of one of cotton duck and spun polyester.

16. The cleaning pad of claim 10 wherein upon assembly, said pad is less than or equal to 0.5 inch thick.

17. The cleaning pad of claim 10 wherein said hem extends the full length of said carrier layer.

18. A flatwork ironer cleaning pad, comprising:
a carrier layer having a leading edge portion, a cleaning portion and a trailing edge portion;
said leading edge portion having a pocket formed at a front edge;
a sand screen sheet disposed on said cleaning portion so that said a substantial portion of said screen layer lays directly upon said cleaning portion;
a hem enveloping each side edge of said sand screen sheet and being stitched to both said sand screen sheet and said cleaning portion; and
a continuous felt layer covering said trailing edge portion.

19. The cleaning pad of claim 18 wherein upon assembly, said pad has a height of less than or equal to 0.5 inch.
